(19) United States
(12) Patent Application Publication
(10) Pub. No.: US 2018/0163847 A1
(43) Pub. Date: Jun. 14, 2018

(54) LUBRICATION SYSTEM OF A TRANSMISSION

(71) Applicants: HYUNDAI MOTOR COMPANY, Seoul (KR); KIA MOTORS CORPORATION, Seoul (KR)

(72) Inventors: Chulmin AHN, Busan (KR); Seok Joon KIM, Yongin-si (KR); Junyoung HA, Ulsan (KR); Su Hyeon MAENG, Seoul (KR); Baekyu KIM, Hwaseong-si (KR); SungGon BYUN, Anyang-si (KR)

(73) Assignees: HYUNDAI MOTOR COMPANY, Seoul (KR); KIA MOTORS CORPORATION, Seoul (KR)

(21) Appl. No.: 15/649,034

(22) Filed: Jul. 13, 2017

(30) Foreign Application Priority Data
Dec. 9, 2016 (KR) 10-2016-0167757

(51) Int. Cl. F16H 57/04; F16H 57/02

(52) U.S. Cl. CPC F16H 57/0423; F16H 57/0457; F16H 57/0424; F16H 57/02

(57) ABSTRACT

A lubrication system of a transmission provides oil passages in an upper portion of a transmission case, and an oil dispensing guider at the transmission case for dispensing churning oil to the oil passages. The oil dispensing guider includes a guiding surface bent at multiple points along a length direction so as to fit bottoms of the oil passages, a slanted guide surface formed along the guiding surface and being slant upward so as to guide oil on the slanted guide surface to the guiding surface, sockets integrally formed at the guiding surface and respectively inserted into the oil passages, and an oil collecting portion formed along an exterior edge of the guiding surface and the slanted guide surface and bent from the exterior edge so as to collect the churning oil splashed toward the oil dispensing guider.

### CROSS-REFERENCE TO RELATED APPLICATION

This application claims priority to and the benefit of Korean Patent Application No. 10-2016-0167757, filed on Dec. 9, 2016, which is incorporated herein by reference in its entirety.

### FIELD

The present disclosure relates to a lubrication system of a transmission.

### BACKGROUND

The statements in this section merely provide background information related to the present disclosure and may not constitute prior art.

A hybrid vehicle refers to a vehicle utilizing two or more types of power sources in order to drive a vehicle. Such a hybrid vehicle is typically a vehicle that utilizes not only an engine that draws a driving torque by combusting fuel but also a drive-motor driven by a power of a rechargeable battery.

When the hybrid electric vehicle accelerates, a motor/generator assists in power for the acceleration and the engine may be efficiently operated by an automatic shift control, thereby enhancing fuel consumption compared with a vehicle having a traditional combustion engine and an automatic transmission.

Such a hybrid electric vehicle is applied with a transmission that installed with a motor/generator.

The transmission of a hybrid electric vehicle typically includes a front cover, a gear case, a motor case, and a rear cover. A gear train is installed in the gear case and covered by the front cover. A motor/generator is installed in the motor case and covered by the rear cover.

The gear train and the motor/generator generate heat and thus a cooling and lubricating system is desired for cooling and lubricating the gear train and the motor/generator.

In order to efficiently supply oil for cooling and lubricating the heat sources, the transmission may be formed with a plurality of oil passages for supplying a churning oil when a differential drive gear operates so that the churning oil may be used for the cooling and lubrication of the heat sources.

The above information disclosed in this Background section is only for enhancement of understanding of the background of the present disclosure and therefore it may contain information that does not form the prior art that is already known to a person of ordinary skill in the art.

### SUMMARY

The present disclosure provides an efficient oil supply system including an oil dispensing guider that may efficiently collect a churning oil of a differential drive gear and dispense the collected oil to a plurality of oil passages formed in a transmission housing.

A lubrication system of a transmission according to one form includes: a transmission case, a plurality of oil passages formed in an upper portion of the transmission case, and an oil dispensing guider configured to dispense churning oil to the plurality of oil passages. The oil dispensing guider includes: a guiding surface bent at multiple points along a length direction of the oil dispensing guider, and configured to fit bottoms of the plurality of oil passages; a slanted guide surface formed along the guiding surface and being slant upward from the guiding surface and configured to guide the churning oil on the slanted guide surface to the guiding surface; a plurality of sockets integrally formed at the guiding surface and respectively inserted into the plurality of oil passages; and an oil collecting portion formed along an exterior edge of the guiding surface and the slanted guide surface and bent from the exterior edge, and configured to collect the churning oil splashed toward the oil dispensing guider.

The oil dispensing guider may further include a plurality of installing section formed at a bottom of the guiding surface and engaged with the transmission case.

The slanted guide surface may include a dissection section between sockets of the plurality of sockets such that a surplus of the collected oil may be free-fallen through the dissection section.

The plurality of sockets may be respectively formed in a circular ring shape configured to fit an oil passage of the plurality of oil passages.

An oil dispensing guider according to an exemplary form of the present disclosure may effectively guide churning oil to oil passages L formed at an upper portion of the transmission case.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a later view of a transmission case employing an oil dispensing guider according to an exemplary form of the present disclosure;

FIG. 2 is an enlarged view of a portion A in FIG. 1;

FIG. 3 and FIG. 4 are respectively a perspective view of an oil dispensing guider according to an exemplary form of the present disclosure; and

FIG. 5 illustrates an operation of an oil dispensing guider according to an exemplary form of the present disclosure.

The drawings described herein are for illustration purposes only and are not intended to limit the scope of the present disclosure in any way.

### DETAILED DESCRIPTION

The present disclosure will be described more fully hereinafter with reference to the accompanying drawings, in which exemplary forms of the present disclosure are shown.

The drawings and description are to be regarded as illustrative in nature and not restrictive, and like reference numerals designate like elements throughout the present disclosure.

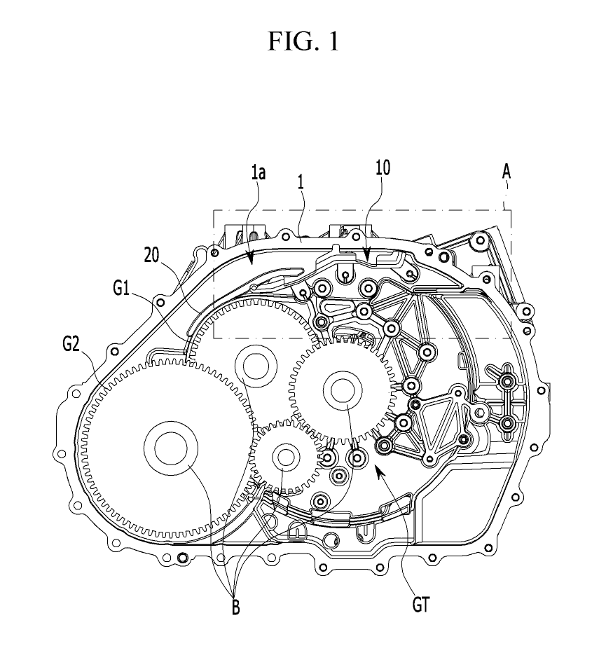

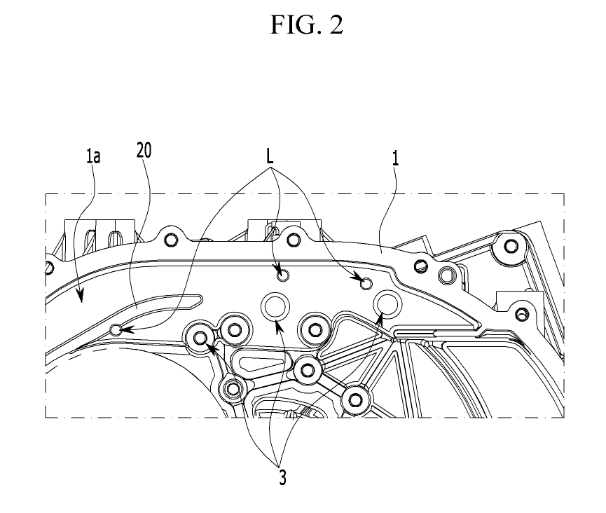

FIG. 1 is a later view of a transmission case employing an oil dispensing guider according to an exemplary form of the present disclosure. FIG. 2 is an enlarged view of a portion A in FIG. 1.

Referring to FIG. 1 and FIG. 2, oil dispensing guider is applied to a transmission case. In more detail, the transmission case includes a front cover (not shown), a gear case 1 enclosing a gear mechanism, a motor case (not shown) enclosing a motor/generator, and rear cover (not shown) that are consecutively arranged. In the drawings, only the gear case 1 is illustrated as the transmission case, and thus the reference numeral 1 is used designate the transmission case and more particularly the gear case.

As shown in FIG. 2, according to an exemplary form of the present disclosure, three oil passages L are formed in the gear case 1 (more particularly, the differential case 1) so as to circulate churning oil by a rotation of a differential drive gear G2. In addition, an oil dispensing guider 10 is employed so as to collect and supply the churning oil by a rotation of a differential drive gear G2 to the three oil passages L.

The three oil passages L is formed in a width direction, i.e., in a direction perpendicular to a plane of FIG. 1, through the gear case 1 and the motor case (not shown).

Oil outlets (not shown) are respectively formed at the three oil passages L so as to free-fall the supplied oil.

The gear mechanism contained in the gear case 1 includes a motor drive gear G1 to drive a motor in the motor case (not shown) and a differential drive gear G2 to drive a differential (not shown) of the transmission.

A leading guider 20 is formed at a case wall 1a and along an exterior diameter of the motor drive gear G1, so as to guide the churning oil of the differential drive gear G2 toward the three oil passages L.

In addition, an oil dispensing guider 10 is further employed at the case wall 1a of the gear case 1, so as to efficiently dispense the churning oil to the respective oil passages L.

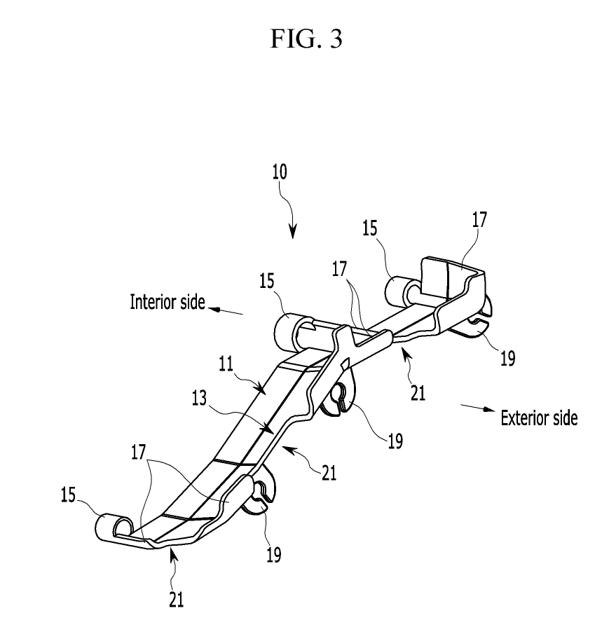

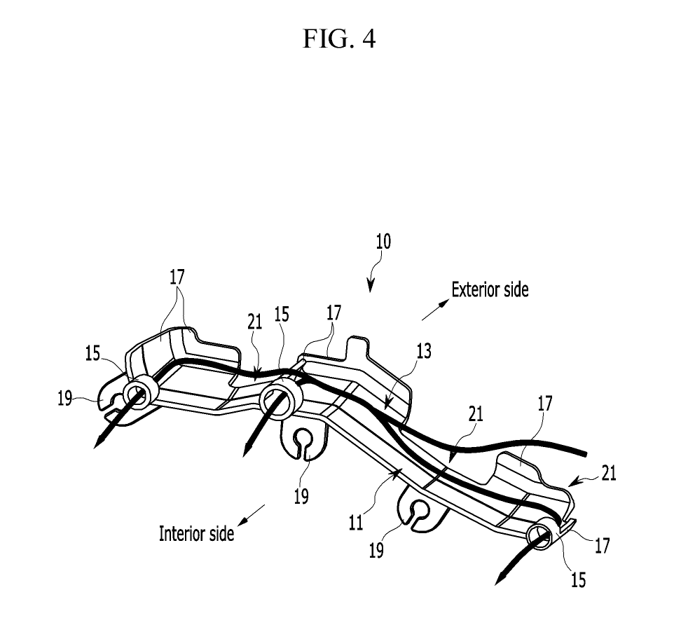

FIG. 3 and FIG. 4 are respectively a perspective view of an oil dispensing guider according to an exemplary form of the present disclosure.

As shown in FIG. 3 and FIG. 4, the oil dispensing guider 10 includes a guiding surface 11, a slanted guide surface 13, three sockets 15, oil collecting portion 17, and installing sections 19.

The guiding surface 11 guides the churning oil of the differential drive gear G2 to respective oil passages L. For this purpose, the guiding surface 11 is bent at multiple points along a length direction, so as to fit bottoms of the three oil passages L.

The slanted guide surface 13 is formed along the guiding surface 11 and slant upward from the guiding surface 11, so as to effectively guide oil on the slanted guide surface 13 to the guiding surface 11.

The three sockets 15 are integrally formed at the guiding surface 11, and respectively inserted into the three oil passages L.

For better fitting of the sockets 15 to the oil passages L, the sockets 15 may be formed in a circular ring shape as in the oil passages L.

The oil collecting portion 17 is formed along an exterior edge of the guiding surface 11 and the slanted guide surface 13, and bent from the exterior edge so as to collect the churning oil splashed toward the oil dispensing guider 10.

A dissection section 21 is formed at the slanted guide surface 13 between sockets 15, such that, when the collected oil by the oil collecting portion 17 is sufficient to be supplied to the oil passages L, a surplus of the collected oil may be free-fallen through the dissection section 21 toward the gear train GT.

The installing sections 19 is integrally formed at a bottom of the guiding surface 11, and fastened to three engagement holes 3 of the gear case 1 by fasteners, such as bolts.

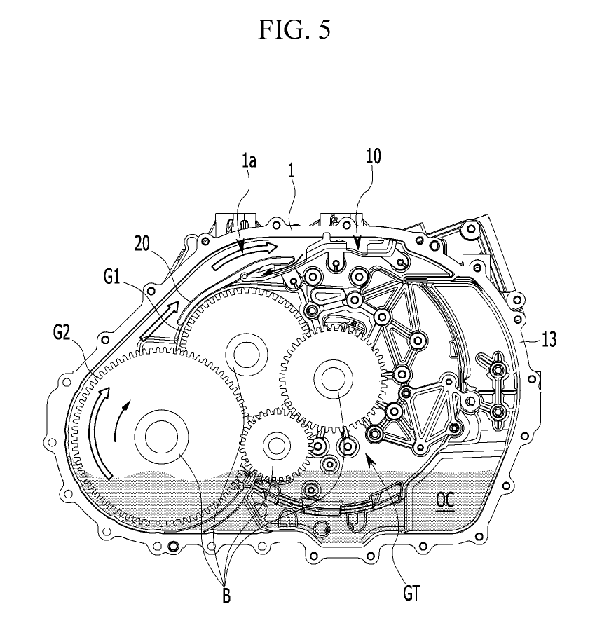

FIG. 5 illustrates an operation of an oil dispensing guider according to an exemplary form of the present disclosure.

Hereinafter, an operation of the oil dispensing guider 10 is described in detail with reference to FIG. 4 and FIG. 5.

Referring to FIG. 5, the differential drive gear G2 rotates in a clockwise in the drawing, and thereby splashes oil stored in an oil chamber OC. Such splashed oil partially runs along an interior edge of the gear case 1 and forms churning oil.

Then, the churning oil is guided toward the oil dispensing guider 10 by the leading guider 20 without being affected by the motor drive gear G1, and the oil guided toward the oil dispensing guider 10 is dispensed to the three oil passages L.

Referring to FIG. 4, the churning oil supplied to the oil dispensing guider 10 is collected by the oil collecting portion 17 and guided by the slanted guide surface 13 and the guiding surface 11, thereby being supplied to the sockets 15. The collected oil is partially free-falls through the dissection section 21.

The oil supplied to the oil passages L through the sockets 15 is supplied to heat sources and used for cooling and lubrication.

The oil free-falling through the dissection section 21 is used for cooling and lubricating the gear train GT and bearings B.

As described above, an oil dispensing guider according to an exemplary form of the present disclosure may effectively guide churning oil to oil passages L formed at an upper portion of the transmission case.

Thereby, heat sources and lubrication-desired members in the transmission case may be effectively cooled and rubricated.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the present disclosure.

### DESCRIPTION OF SYMBOLS

1: gear case
1a: case wall
10: oil dispensing guider
11: guiding surface
13: slanted guide surface
15: socket
17: oil collecting portion
19: installing section
20: leading guider
21: dissection section
L: oil passage
B: bearing
GT: gear train
OC: oil chamber

What is claimed is:

1. A lubrication system of a transmission, comprising:
a transmission case;
a plurality of oil passages formed in an upper portion of the transmission case; and
an oil dispensing guider configured to dispense churning oil to the plurality of oil passages,
wherein the oil dispensing guider comprises:
a guiding surface bent at multiple points along a length direction of the oil dispensing guider, and configured to fit bottoms of the plurality of oil passages;
a slanted guide surface formed along the guiding surface and being slant upward from the guiding surface, and configured to guide the churning oil on the slanted guide surface to the guiding surface;
a plurality of sockets integrally formed at the guiding surface, and respectively inserted into the plurality of oil passages; and
an oil collecting portion formed along an exterior edge of the guiding surface and the slanted guide surface, and bent from the exterior edge, and configured to collect the churning oil splashed toward the oil dispensing guider.

2. The lubrication system of claim 1, wherein the oil dispensing guider further comprises a plurality of installing section formed at a bottom of the guiding surface and engaged with the transmission case.

3. The lubrication system of claim 1, wherein the slanted guide surface comprises a dissection section between sockets of the plurality of sockets such that a surplus of the collected churning oil is free-fallen through the dissection section.

4. The lubrication system of claim 1, wherein the plurality of sockets are respectively formed in a circular ring shape configured to fit an oil passage of the plurality of oil passages.

5. A lubrication system of a transmission, comprising:
a transmission case;
at least three oil passages formed in an upper portion of the transmission case; and
an oil dispensing guider configured to dispense churning oil to the at least three oil passages,
wherein the oil dispensing guider comprises:
a guiding surface bent at multiple points along a length direction of the oil dispensing guider, and configured to fit bottoms of the at least three oil passages;
a slanted guide surface formed along the guiding surface and being slant upward from the guiding surface, and configured to guide the churning oil on the slanted guide surface to the guiding surface;
at least three sockets integrally formed at the guiding surface, and respectively inserted into the at least three oil passages;
an oil collecting portion formed along an exterior edge of the guiding surface and the slanted guide surface, and bent from the exterior edge, and configured to collect the churning oil splashed toward the oil dispensing guider; and
at least three installing section formed at a bottom of the guiding surface and engaged with the transmission case.

6. The lubrication system of claim 5, wherein the slanted guide surface comprises a dissection section between the at least three sockets such that a surplus of the collected oil is free-fallen through the dissection section.

7. The lubrication system of claim 5, wherein the sockets are respectively formed in a circular ring shape configured to fit an oil passage of the at least three oil passages.
